(19) United States
(12) Patent Application Publication
(10) Pub. No.: US 2013/0028081 A1
(43) Pub. Date: Jan. 31, 2013

(54) METHOD AND APPARATUS FOR BALANCING LOAD AND REDUCING CALL BLOCKING IN A TD-SCDMA SYSTEM

(71) Applicants: Ming Yang, San Diego, CA (US); Tom Chin, San Diego, CA (US); Qingxin Chen, Del Mar, CA (US); Guangming Shi, San Diego, CA (US)

(72) Inventors: Ming Yang, San Diego, CA (US); Tom Chin, San Diego, CA (US); Qingxin Chen, Del Mar, CA (US); Guangming Shi, San Diego, CA (US)

(21) Appl. No.: 13/359,167

(22) Filed: Jan. 26, 2012

Related U.S. Application Data
(60) Provisional application No. 61/512,201, filed on Jul. 27, 2011.

(51) Int. Cl. H04W 28/08; H04W 36/22; H04W 48/20

(52) U.S. Cl. 370/230

(57) ABSTRACT

A method, an apparatus, and a computer program product for wireless communication are provided in connection with providing a process for balancing loads and reducing call blocking in a TD-SCDMA network. In one example, a user equipment (UE) is equipped to obtain a received signal code power (RSCP) value and a load factor value for each of one or more cells. The UE may be further equipped to rank the one or more cells based on a cell selection value derived from both the RSCP value and the load factor value and select a serving cell from the ranked one or more cells.

### CROSS-REFERENCE TO RELATED APPLICATION(S)

This application claims the benefit of U.S. Provisional Application Ser. No. 61/512,201, entitled “METHOD AND APPARATUS FOR BALANCING LOAD AND REDUCING CALL BLOCKING IN A TD-SCDMA SYSTEM” and filed on Jul. 27, 2011, which is expressly incorporated by reference herein in its entirety.

### BACKGROUND

1. Field

Aspects of the present disclosure relate generally to wireless communication systems, and more particularly, to providing an effective process for balancing loads and reducing call blocking in a Time Division-Synchronous Code Division Multiple Access (TD-SCDMA) network.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and TD-SCDMA. For example, China is pursuing TD-SCDMA as the underlying air interface in the UTRAN architecture with its existing GSM infrastructure as the core network. The UMTS also supports enhanced 3G data communications protocols, such as High Speed Downlink Packet Data (HSDPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more aspects and corresponding disclosure thereof, various aspects are described in connection with providing a process for balancing loads and reducing call blocking in a TD-SCDMA network. In one example, a UE is equipped to obtain a received signal code power (RSCP) value and a load factor value for each of one or more cells. The UE may be further equipped to rank the one or more cells based on a cell selection value derived from both the RSCP value and the load factor value and select a serving cell from the ranked one or more cells.

According to related aspects, a method for providing a process for balancing loads and reducing call blocking in a TD-SCDMA network is provided. The method can include obtaining a RSCP value and a load factor value for each of one or more cells. Further, the method can include ranking the one or more cells based on a cell selection value derived from both the RSCP value and the load factor value. Moreover, the method may include selecting a serving cell from the ranked one or more cells.

Another aspect relates to a wireless communications apparatus enabled to provide a process for balancing loads and reducing call blocking in a TD-SCDMA network. The wireless communications apparatus can include means for obtaining a RSCP value and a load factor value for each of one or more cells. Further, the wireless communications apparatus can include means for ranking the one or more cells based on a cell selection value derived from both the RSCP value and the load factor value. Moreover, the wireless communications apparatus can include means for selecting a serving cell from the ranked one or more cells.

Another aspect relates to a wireless communications apparatus. The apparatus can include a processing system configured to obtain a RSCP value and a load factor value for each of one or more cells. Further, the processing system may be configured to rank the one or more cells based on a cell selection value derived from both the RSCP value and the load factor value. Moreover, the processing system may further be configured to select a serving cell from the ranked one or more cells.

Still another aspect relates to a computer program product, which can have a computer-readable medium including code for obtaining a RSCP value and a load factor value for each of one or more cells. Further, the computer-readable medium can include code for ranking the one or more cells based on a cell selection value derived from both the RSCP value and the load factor value. Moreover, the computer-readable medium can include code for selecting a serving cell from the ranked one or more cells.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram conceptually illustrating an example of a wireless communications networks.

FIG. 2 is a block diagram conceptually illustrating an example of a frame structure in a wireless communications network.

FIG. 3 is a block diagram illustrating Radio Resource Control (RRC) through Physical (PHY) layer interfaces according to an aspect.

FIG. 4 depicts an example TD-SCDMA based system with multiple UEs communicating with a node-B, as time progresses according to an aspect.

FIG. 5 is a block diagram conceptually illustrating an example of a Node B in communication with a user equipment in a wireless communications network.

FIG. 6 a block diagram conceptually illustrating an example wireless communications network according to an aspect.

FIG. 7 is a functional block diagram conceptually illustrating example blocks executed to implement the functional characteristics of one aspect of the present disclosure.

FIG. 8 is a block diagram of an example user equipment for facilitating load balancing and reducing call blocking according to an aspect.

FIG. 9 is an electrical component diagram of an example for apparatus according to an aspect.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

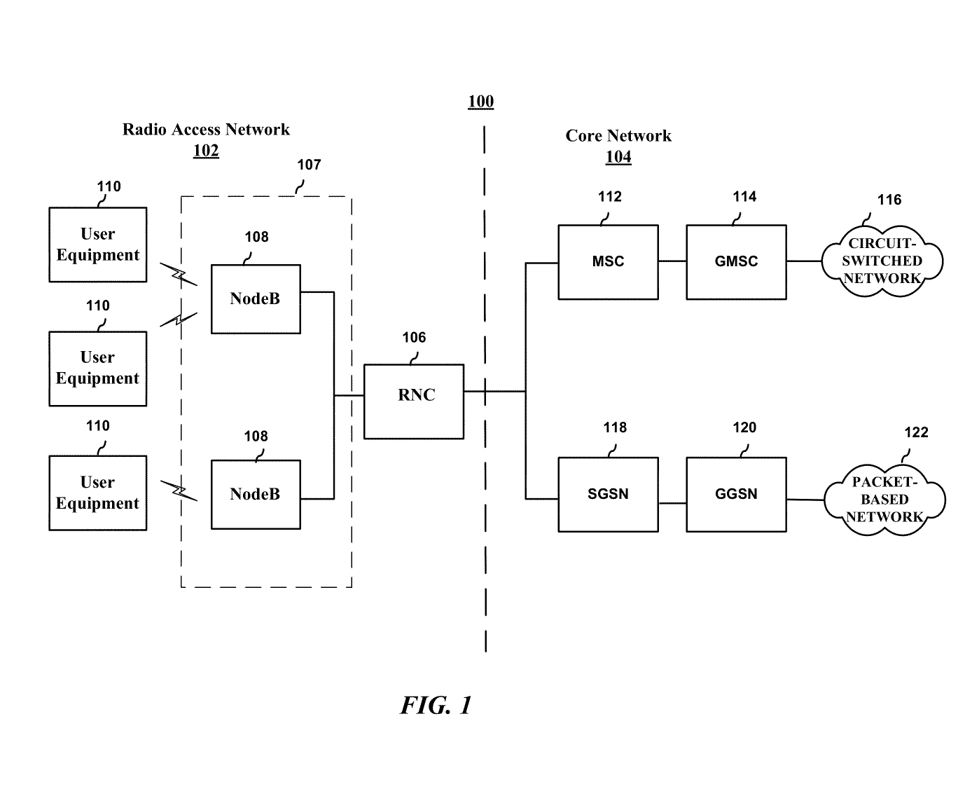

Turning now to FIG. 1, a block diagram is shown illustrating an example of a wireless communications networks 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two Node Bs 108 are shown, however, the RNS 107 may include any number of wireless Node Bs. The Node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the Node Bs 108. The downlink (DL), also called the forward link, refers to the communication link from a Node B to a UE, and the uplink (UL), also called the reverse link, refers to the communication link from a UE to a Node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a Node B 108 and a UE 110, but divides uplink and downlink transmissions into different time slots in the carrier.

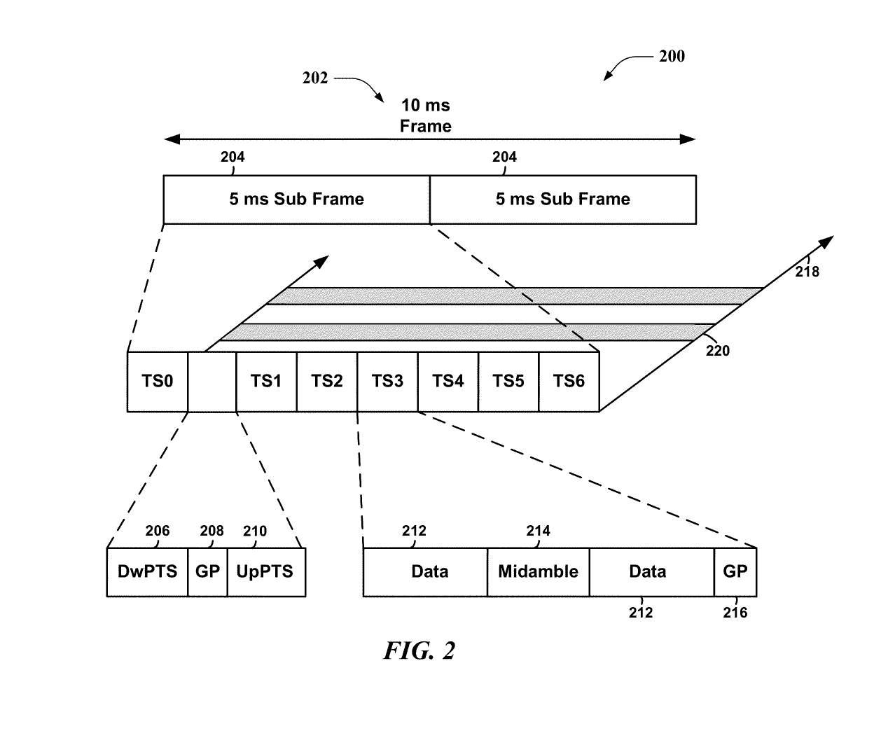

FIG. 2 illustrates a frame structure 200 for a TD-SCDMA carrier. The TD-SCDMA carrier, as illustrated, has a frame 202 that is 10 ms in length. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 separated by a midamble 214 and followed by a guard period (GP) 216. The midamble 214 may be used for features, such as channel estimation, while the GP 216 may be used to avoid inter-burst interference.

Additionally, in an optional aspect, where a wireless communications network supports multiple carriers, such as in an N-frequency TD-SCDMA supported network, the frame structure 200 may be used for each carrier 220 where carriers are defined within different frequencies 218. In one aspect, each carrier 220 may be allocated a 1.6 MHz frequency 218 band.

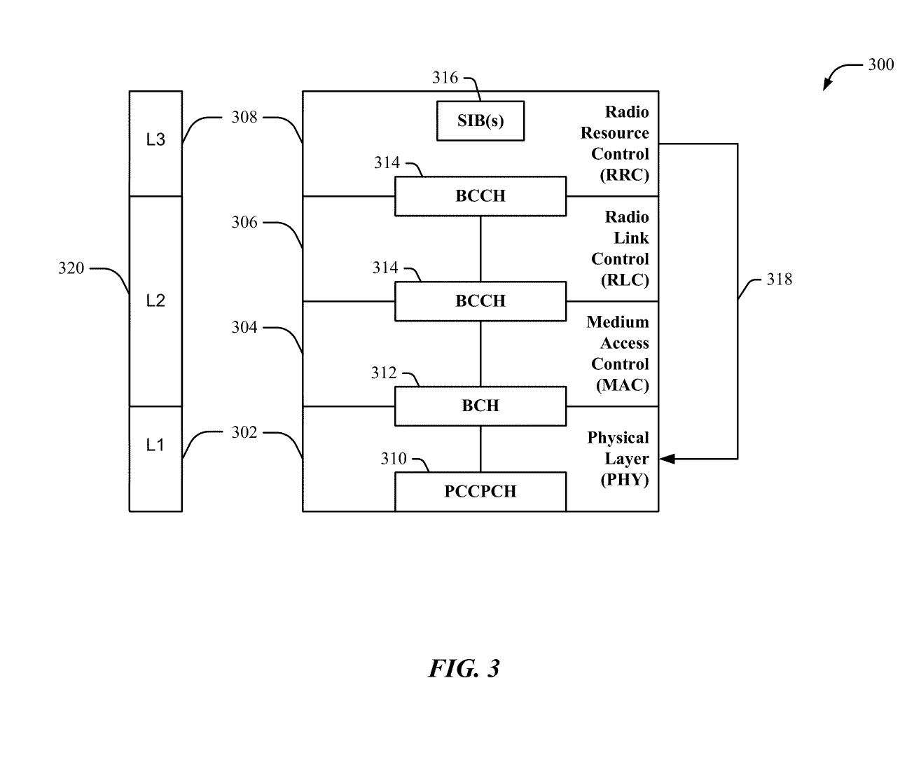

FIG. 3 illustrates a radio protocol architecture 300 for the UE is shown with three layers: Layer 1, Layer 2, and Layer 3. Layer 1 is the lowest layer and implements various physical layer signal processing functions. Layer 1 will be referred to herein as the physical layer 302. Layer 2 (L2 layer) 320 is above the physical layer 302, includes medium access control (MAC) 304 and radio link control (RLC) 306 sublayers, and is responsible for the link between the UE and eNB over the physical layer 302. Layer 3 308 includes radio resource control (RRC) layer and facilitates, among other actions, connection establishment and release, and broadcasting system information (e.g., one or more system information blocks (SIBs) 316).

In operation, a UE may listen to a broadcast logical channel (BCCH) 314 in order to collect system information blocks (SIB) 316. The demodulation of BCCH logical channel 314 at a radio resource control (RRC) layer 308, related to a radio link control (RLC) layer 306, has a broadcast channel (BCH) transport channel 314 on the medium access control (MAC) layer 304 and is mapped onto a Primary Common Control Physical Channel (P-CCPCH) 310 of a physical L1 (PHY) layer 302. Further, a SIB scheduling information interface 320 communicates between the RRC layer 308 and the PHY L1 layer 302 to selectively monitor the P-CCPCH 310 as well.

In one aspect, such as during cell selection, cell reselection, and/or circuit switched fallback (CSFB), P-CCPCH 310 may be monitored to obtain a receive signal code power (RSCP) value. In an N-frequency system, P-CCPCH 310 may be broadcast only on a primary carrier and during the TS0 timeslot. In another aspect, SIBs 316 may include various system information message types. For example, a SIB type 7 message may include loading information for each cell, and/or each carrier within a N-frequency cell. Such loading information, along with the RSCP value may be used to a UE to rank various cells and select a serving cell based on the rankings.

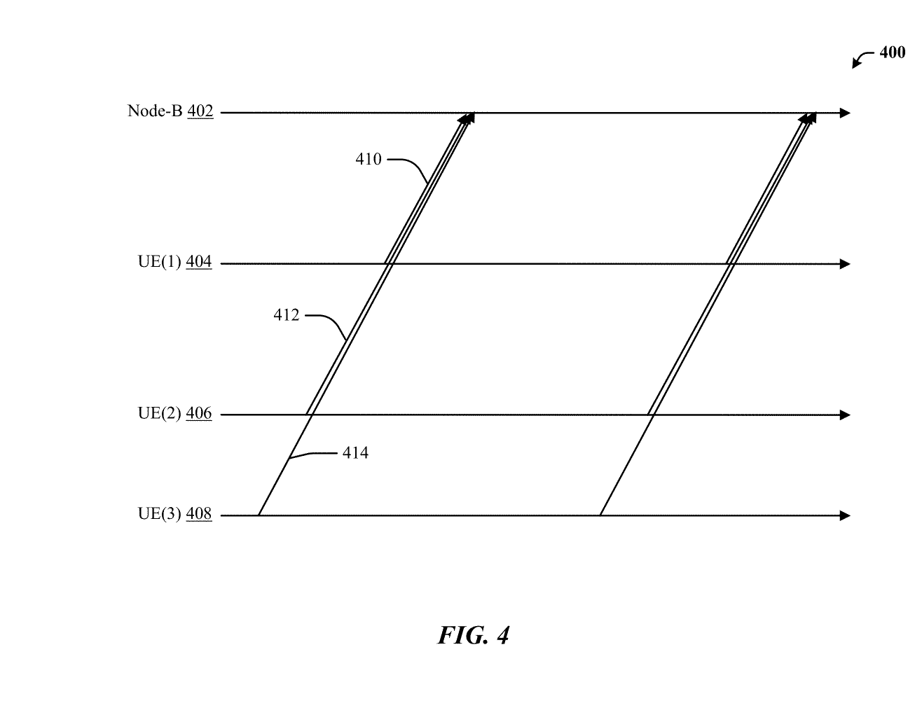

Turning now to FIG. 4, an example TD-SCDMA based system 400 with multiple UEs (404, 406, 408) communicating with a node-B 402, as time progresses, is illustrated. Generally, in TD-SCDMA systems, multiple UEs may share a common bandwidth in communication with a node-B 402. Additionally, one aspect in TD-SCDMA systems, as compared to CDMA and WCDMA systems, is UL synchronization. That it, in TD-SCDMA systems, different UEs (404, 406, 408) may synchronize on the uplink (UL) such that all UE (404, 406, 408) transmitted signals arrives at the Node B (NB) at approximately the same time. For example, in the depicted aspect, various UEs (404, 406, 408) are located at various distances from the serving node-B 402. Accordingly, in order for the UL transmission to reach the node-B 402 at approximately the same time, each UE may originate transmissions at different times. For example, UE 408 may be farthest from node-B 402 and may perform an UL transmission 414 before closer UEs. Additionally, UE 406 may be closer to node-B 402 than UE 408 and may perform an UL transmission 412 after UE 408. Similarly, UE 404 may be closer to node-B 402 than UE 406 and may perform an UL transmission 410 after UEs 406 and 408. The timing of the UL transmissions (410, 412, 414) may be such that the signals arrive at the node-B at approximately the same time.

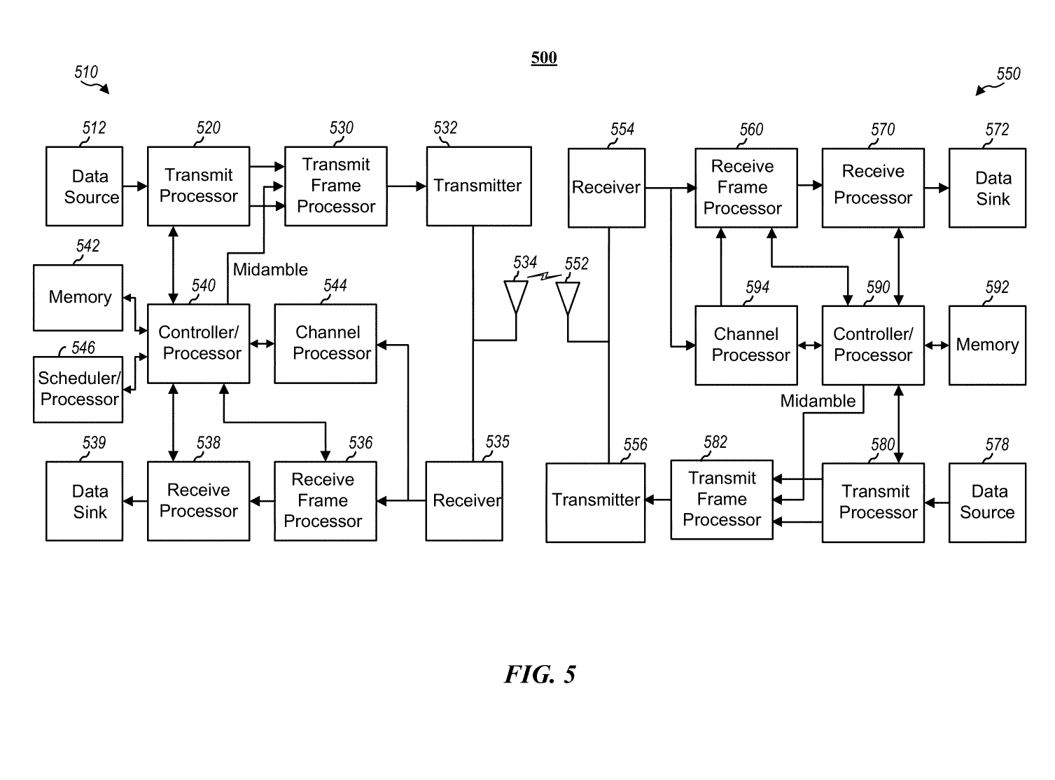

FIG. 5 is a block diagram of a Node B 510 in communication with a UE 550 in a RAN 500, where the RAN 500 may be the RAN 102 in FIG. 1, the Node B 510 may be the Node B 108 in FIG. 1, and the UE 550 may be the UE 110 in FIG. 1. In the downlink communication, a transmit processor 520 may receive data from a data source 512 and control signals from a controller/processor 540. The transmit processor 520 provides various signal processing functions for the data and control signals, as well as reference signals (e.g., pilot signals). For example, the transmit processor 520 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 544 may be used by a controller/processor 540 to determine the coding, modulation, spreading, and/or scrambling schemes for the transmit processor 520. These channel estimates may be derived from a reference signal transmitted by the UE 550 or from feedback contained in the midamble 214 (FIG. 2) from the UE 550. The symbols generated by the transmit processor 520 are provided to a transmit frame processor 530 to create a frame structure. The transmit frame processor 530 creates this frame structure by multiplexing the symbols with a midamble 214 (FIG. 2) from the controller/processor 540, resulting in a series of frames. The frames are then provided to a transmitter 532, which provides various signal conditioning functions including amplifying, filtering, and modulating the frames onto a carrier for downlink transmission over the wireless medium through smart antennas 534. The smart antennas 534 may be implemented with beam steering bidirectional adaptive antenna arrays or other similar beam technologies.

At the UE 550, a receiver 554 receives the downlink transmission through an antenna 552 and processes the transmission to recover the information modulated onto the carrier. The information recovered by the receiver 554 is provided to a receive frame processor 560, which parses each frame, and provides the midamble 214 (FIG. 2) to a channel processor 594 and the data, control, and reference signals to a receive processor 570. The receive processor 570 then performs the inverse of the processing performed by the transmit processor 520 in the Node B 510. More specifically, the receive processor 570 descrambles and despreads the symbols, and then determines the most likely signal constellation points transmitted by the Node B 510 based on the modulation scheme. These soft decisions may be based on channel estimates computed by the channel processor 594. The soft decisions are then decoded and deinterleaved to recover the data, control, and reference signals. The CRC codes are then checked to determine whether the frames were successfully decoded. The data carried by the successfully decoded frames will then be provided to a data sink 572, which represents applications running in the UE 550 and/or various user interfaces (e.g., display). Control signals carried by successfully decoded frames will be provided to a controller/processor 590. When frames are unsuccessfully decoded by the receiver processor 570, the controller/processor 590 may also use an acknowledgement (ACK) and/or negative acknowledgement (NACK) protocol to support retransmission requests for those frames.

In the uplink, data from a data source 578 and control signals from the controller/processor 590 are provided to a transmit processor 580. The data source 578 may represent applications running in the UE 550 and various user interfaces (e.g., keyboard). Similar to the functionality described in connection with the downlink transmission by the Node B 510, the transmit processor 580 provides various signal processing functions including CRC codes, coding and interleaving to facilitate FEC, mapping to signal constellations, spreading with OVSFs, and scrambling to produce a series of symbols. Channel estimates, derived by the channel processor 594 from a reference signal transmitted by the Node B 510 or from feedback contained in the midamble transmitted by the Node B 510, may be used to select the appropriate coding, modulation, spreading, and/or scrambling schemes. The symbols produced by the transmit processor 580 will be provided to a transmit frame processor 582 to create a frame structure. The transmit frame processor 582 creates this frame structure by multiplexing the symbols with a midamble 214 (FIG. 2) from the controller/processor 590, resulting in a series of frames. The frames are then provided to a transmitter 556, which provides various signal conditioning functions including amplification, filtering, and modulating the frames onto a carrier for uplink transmission over the wireless medium through the antenna 552.

The uplink transmission is processed at the Node B 510 in a manner similar to that described in connection with the receiver function at the UE 550. A receiver 535 receives the uplink transmission through the antenna 534 and processes the transmission to recover the information modulated onto the carrier. The information recovered by the receiver 535 is provided to a receive frame processor 536, which parses each frame, and provides the midamble 214 (FIG. 2) to the channel processor 544 and the data, control, and reference signals to a receive processor 538. The receive processor 538 performs the inverse of the processing performed by the transmit processor 580 in the UE 550. The data and control signals carried by the successfully decoded frames may then be provided to a data sink 539 and the controller/processor, respectively. If some of the frames were unsuccessfully decoded by the receive processor, the controller/processor 540 may also use an acknowledgement (ACK) and/or negative acknowledgement (NACK) protocol to support retransmission requests for those frames.

The controller/processors 540 and 590 may be used to direct the operation at the Node B 510 and the UE 550, respectively. For example, the controller/processors 540 and 590 may provide various functions including timing, peripheral interfaces, voltage regulation, power management, and other control functions. The computer readable media of memories 542 and 592 may store data and software for the Node B 510 and the UE 550, respectively. A scheduler/processor 546 at the Node B 510 may be used to allocate resources to the UEs and schedule downlink and/or uplink transmissions for the UEs.

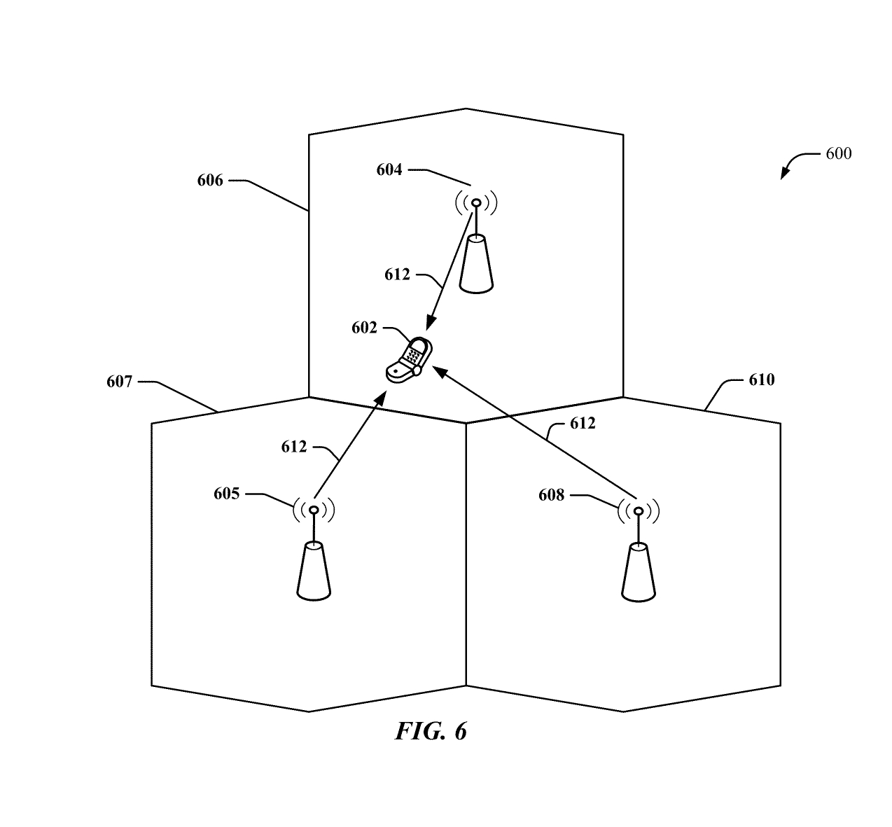

FIG. 6 illustrates a wireless communications system 600. System 600 may include multiple cells (606, 607, 610), which in cell (606, 610) including one or more node-Bs (604, 605, 608). Further, system 600 may provide a UE 602 with support from various radio access technologies (RATs). For example, as depicted in FIG. 6, cells 606 and 607 may provide support for a TD-SCDMA RAT, while cell 610 may provide support for a LTE RAT. A UE 602 operating within system 600 may be receiving signals 612 from one or more of the node-Bs (604, 605, 608). Signaling 612 may include system information and/or may be used to obtain measurements associated with each of the cells (606, 607, 610) and/or node-Bs (604, 605, 608).

Generally, for example in a WCDMA system, cell load information may be indirectly indicated to a UE. In one aspect, where a downlink load is high, a ratio of energy per chip over total noise (e.g., Ec/No) measured by the UE 602 from a signal on a channel (e.g., common pilot channel (CPICH)) may be low. When an uplink load is high, uplink interference broadcast in a system information block (e.g., SIB 7) may be high. Using such information, a UE 602 may not choose a heavily loaded cell during redirection or cell reselection.

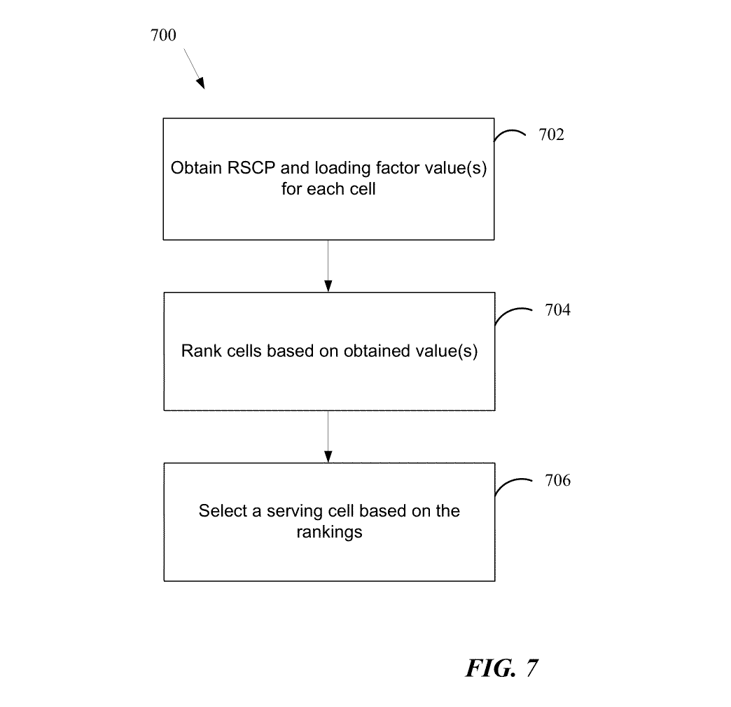

As currently implemented, a TD-SCDMA system does not provide such load factor information to UEs. Further, TD-SCDMA systems do not currently provide mechanism that may allow a UE to indirectly measure loading for a cell. Rather, cell selection is primary based on a distance between the UE and the cell. Such distance information may be provided through a measuring a primary common control physical channel (PCCPCH) received signal code power (RSCP). Additionally, loading information may not be indicated for N-frequency cells since PCCPCH is only transmitted on a primary frequency in time slot 0. As such, a UE 602 may not be provided with loading and/or interference information for secondary frequencies and other time slots. Another aspect of a TD-SCDMA system is that the capacity is a hard capacity. In other words, a TD-SCDMA system may be limited to codes/time slots on a limited frequency bandwidth (e.g., 1.5 Mhz). FIGS. 7-9 describe apparatuses and methods to effectively balancing loads and reducing call blocking in a TD-SCDMA network. In one aspect, a TD-SCDMA based node-B (604, 605) may include a load factor value in cell selection, redirection, and/or reselection information in a signal 612 to the UE 602. As such, the UE 602 may select a serving cell, based not only on a distance value (e.g., RSCP), but also loading information associated with the cell (606, 607).

FIG. 7 illustrates various methodologies in accordance with various aspects of the presented subject matter. While, for purposes of simplicity of explanation, the methodologies are shown and described as a series of acts or sequence steps, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 7 is a functional block diagram 700 illustrating example blocks executed in conducting wireless communication according to one aspect of the present disclosure. In block 702, a UE may obtain distance information (e.g., a RSCP value) and a load factor for each of one or more cells. In one aspect, a load factor in a N-frequency cell may be broadcast to a UE using an information element in a SIB7 based on available uplink and/or downlink resources (e.g., percentage of available or occupied time slots and code) for primary and/or secondary frequencies. The load factor can be used to balance load, reduce call blocking rate, etc. In one aspect, the load factor value may be included in an information element from a serving cell along with cell redirection information. In such an aspect, the reception of the cell redirection information may be included as part of a circuit switch fall back (CSFB) procedure. Further, the CSFB procedure may be implemented to redirect communication from a LTE network to a TD-SCDMA network. In other words, a serving cell in an LTE network may provide loading information for one or more TD-SCDMA cells (e.g., inter radio access technology (RAT) loading information). In another aspect, the loading factor value may be included in an information element from the one or more cells as part of a cell selection/reselection procedure. In another aspect, the loading factor value may be included in an information element as part of a neighbor list. In still another aspect, since only frequency may be included in redirection information, the UE may scan the frequencies to find the best cell base on, not only PCCPCH RSCP measurement (e.g., the distance between the UE and the cell) but also considers a loading factor indicated in a SIB information element included with redirection information. Taking into account multiple factors when determining which cell to select improves redirection success rate, and correspondingly may reduce the latency of call redirection, such as CSFB from LTE to TD-SCDMA.

In addition, block 704 the UE may rank the one or more cells based on a cell selection value derived from both the RSCP value and the load factor value. In other words, the load factor can be used as an input for a serving/neighbor cell rank procedure as a weight value. Furthermore, block 706 the UE may select a serving cell from the ranked one or more cells. For example, if a cell is heavily loaded, PCCPCH RSCP may be high and/or a load factor may indicate a high percentage of loading, UE may not reselect to or stay on the cell. As such, loading may be balanced when a UE is in idle mode, and potential call blocking may be reduced in case of UE making call/receiving paging by camping the UE on non-heavily load cell.

In one configuration, the apparatus 550 for wireless communication includes means for obtaining a RSCP value and a load factor value for each of one or more cells, means for ranking the one or more cells based on a cell selection value derived from both the RSCP value and the load factor value, and means for selecting a serving cell from the ranked one or more cells. In one aspect, the aforementioned means may be the processor(s) 570, 580, and 590 configured to perform the functions recited by the aforementioned means. In another aspect, the aforementioned means may be a module or any apparatus configured to perform the functions recited by the aforementioned means. In one configuration, apparatus 550 includes means for selecting a highest ranked cell of the one or more cells. In another configuration, apparatus 550 includes means for selecting a cell of the one or more cell that has a cell selection value above a threshold value. In another configuration, apparatus 550 includes means for receiving the load factor value in an information element from a serving cell with cell redirection information. In another configuration, apparatus 550 includes means for receiving the load factor value in an information element from the one or more cells as part of a cell selection or cell reselection procedure. In another configuration, apparatus 550 includes means for receiving a neighbor list identifying the one or more cells, and means for receiving the load factor value for each cell in the neighbor list from each of the cells in the neighbor list. In another configuration, apparatus 550 includes means for obtaining further comprises means for receiving the load factor value information element communicated through an information element in a SIB7, an information element in a cell parameter identifier, information elements associated with each cell in a neighbor list, etc.

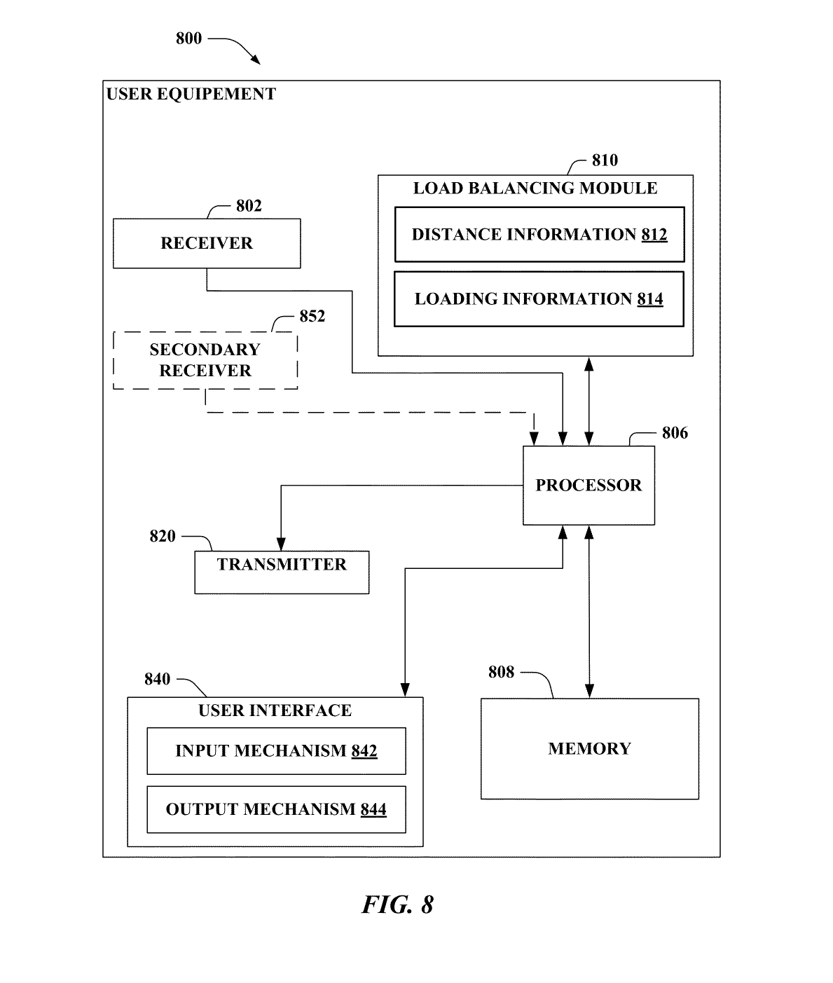

FIG. 8 illustrates a user equipment (UE) 800 (e.g. a client device, wireless communications device (WCD) etc.) that provides an effective process for balancing loads and reducing call blocking in a TD-SCDMA network. UE 800 comprises receiver 802 that receives one or more signal from, for instance, one or more receive antennas (not shown), performs typical actions on (e.g., filters, amplifies, downconverts, etc.) the received signal, and digitizes the conditioned signal to obtain samples. Receiver 802 can further comprise an oscillator that can provide a carrier frequency for demodulation of the received signal and a demodulator that can demodulate received symbols and provide them to processor 806 for channel estimation. In one aspect, UE 800 may further comprise secondary receiver 852 and may receive additional channels of information.

Processor 806 can be a processor dedicated to analyzing information received by receiver 802 and/or generating information for transmission by one or more transmitters 820 (for ease of illustration, only one transmitter is shown), a processor that controls one or more components of UE 800, and/or a processor that both analyzes information received by receiver 802 and/or secondary receiver 852, generates information for transmission by transmitter 820 for transmission on one or more transmitting antennas (not shown), and controls one or more components of UE 800. In one aspect of UE 800, processor 806 may include at least one processor and memory, wherein the memory may be within the at least one processor 806. By way of example and not limitation, the memory could include on-board cache or general purpose register.

UE 800 can additionally comprise memory 808 that is operatively coupled to processor 806 and that can store data to be transmitted, received data, information related to available channels, data associated with analyzed signal and/or interference strength, information related to an assigned channel, power, rate, or the like, and any other suitable information for estimating a channel and communicating via the channel. Memory 808 can additionally store protocols and/or algorithms associated with estimating and/or utilizing a channel (e.g., performance based, capacity based, etc.).

In aspect, processor 806 coupled to memory 808 may provide means for obtaining a RSCP value and a load factor value for each of one or more cells, means for ranking the one or more cells based on a cell selection value derived from both the RSCP value and the load factor value, and means for selecting a serving cell from the ranked one or more cells.

It will be appreciated that the data store (e.g., memory 808) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory 808 of the subject systems and methods is intended to comprise, without being limited to, these and any other suitable types of memory.

UE 800 can further have load balancing module 810 that assists the UE 800 with cell access in a network while accounting for cell loading. In one aspect, load balancing module 810 further includes distance information 812 and loading information 814. In one aspect, distance information 812 may include RSCP for PCCPCH. Such distance information may be communicated on a primary frequency of an N-frequency cell using time slot 0. In one aspect, loading information 814 may include a loading factor for each cell. In one aspect, the loading factor may be communicated in an information element added to a message received by UE 800. For example, the loading factor may be included in an information element associated with a SIB 7, SIB 11 neighbor list, a cell parameter identifier, etc. In one aspect, loading information 814 may indicate a level (e.g., percentage) of loading experienced by the cell.

Additionally, client device 800 may include user interface 840. User interface 840 may include input mechanisms 842 for generating inputs into UE 800, and output mechanism 844 for generating information for consumption by the user of wireless device 800. For example, input mechanism 842 may include a mechanism such as a key or keyboard, a mouse, a touch-screen display, a microphone, etc. Further, for example, output mechanism 844 may include a display, an audio speaker, a haptic feedback mechanism, a Personal Area Network (PAN) transceiver etc. In the illustrated aspects, output mechanism 844 may include a display operable to present content that is in image or video format or an audio speaker to present content that is in an audio format.

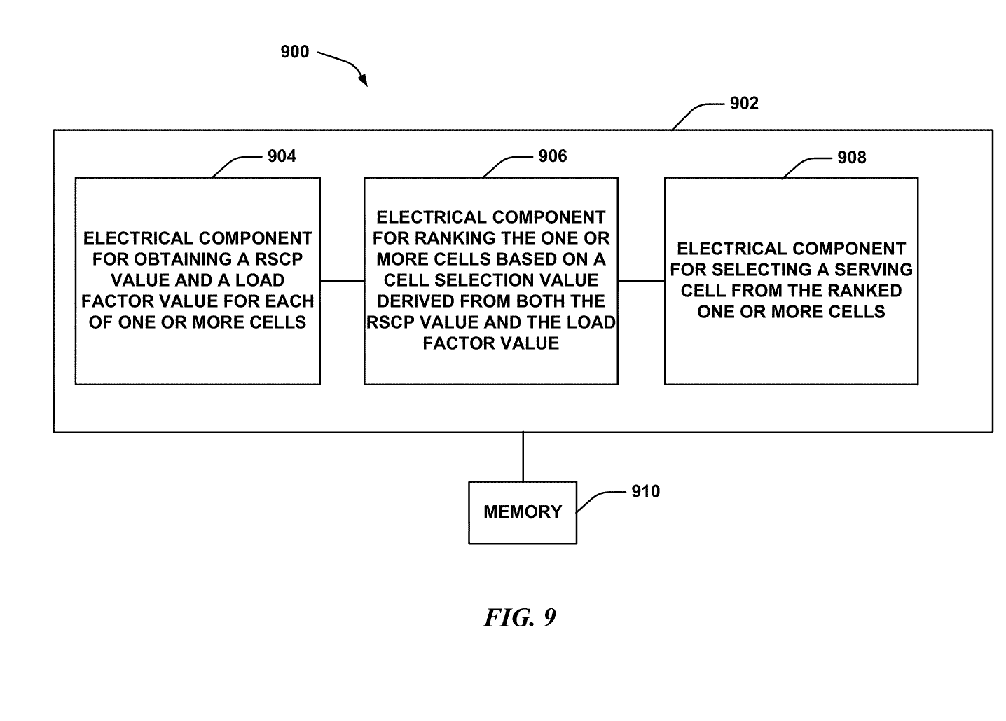

FIG. 9 illustrates an example system 900 for providing a process for balancing loads and reducing call blocking in a TD-SCDMA network. For example, system 900 can reside at least partially within a wireless device (e.g., UE 800). It is to be appreciated that system 900 is represented as including functional blocks, which can be functional blocks that represent functions implemented by a processor, software, or combination thereof (e.g., firmware). System 900 includes a logical grouping 902 of electrical components that can act in conjunction.

For instance, logical grouping 902 can include an electrical component for obtaining a received signal code power (RSCP) value and a load factor value for each of one or more cells 904. In one aspect, the load factor value indicates a percentage value of loading (e.g., time slots, codes, frequencies, etc.) in a cell. In an aspect, the RSCP value may indicate a distance between the UE and a node-B from which the RSCP transmission is received. In an aspect, the electrical component 904 may further be configured for receiving the load factor value in an information element from a serving cell with cell redirection information. In such an aspect, the electrical component 904 may further be configured for receiving the cell redirection information as part of a CSFB procedure. Further, in such an aspect, the CSFB procedure includes redirecting communication from a LTE network to a TD-SCDMA network. In another aspect, the electrical component 904 may further be configured for receiving the load factor value in an information element from the one or more cells as part of a cell selection or cell reselection procedure. In still another aspect, the electrical component 904 may further be configured for receiving a neighbor list identifying the one or more cells, and receiving the load factor value for each cell in the neighbor list from each of the cells in the neighbor list. In another aspect, the electrical component 904 may be further configured for receiving the load factor value in an information element, wherein the information element is communicated through, an information element in a SIB type 7, an information element in a cell parameter identifier, information elements associated with each cell in a neighbor list, etc.

Further, logical grouping 902 can include an electrical component for ranking the one or more cells based on a cell selection value derived from both the RSCP value and the load factor value 906. This can be based on receiving the authorization and/or parameters received in the authorization message, as described.

Moreover, logical grouping 902 can include an electrical component for selecting a serving cell from the ranked one or more cells 908. In an aspect, the electrical component 908 may further be configured for selecting a highest ranked cell of the one or more cells. In another aspect, the electrical component 908 may further be configured for selecting a cell of the one or more cell that has a cell selection value above a threshold value.

Additionally, system 900 can include a memory 910 that retains instructions for executing functions associated with the electrical components 904, 906, and 908, stores data used or obtained by the electrical components 904, 906, 908, etc. While shown as being external to memory 910, it is to be understood that one or more of the electrical components 904, 906, and 908 can exist within memory 910. In one example, electrical components 904, 906, and 908 can include at least one processor, or each electrical component 904, 906, and 908 can be a corresponding module of at least one processor. Moreover, in an additional or alternative example, electrical components 904, 906, and 908 can be a computer program product including a computer readable medium, where each electrical component 904, 906, and 908 can be corresponding code.

Several aspects of a telecommunications system has been presented with reference to a TD-SCDMA system. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
obtaining a received signal code power (RSCP) value and a load factor value for each of one or more cells;
ranking the one or more cells based on a cell selection value derived from both the RSCP value and the load factor value; and
selecting a serving cell from the ranked one or more cells.

2. The method of claim 1, wherein the selecting further comprises selecting a highest ranked cell of the one or more cells.

3. The method of claim 1, wherein the selecting further comprises selecting a cell of the one or more cell that has a cell selection value above a threshold value.

4. The method of claim 1, wherein RSCP value indicates a distance between a user equipment (UE) and a node-B from which the RSCP transmission is received.

5. The method of claim 1, wherein the obtaining further comprises:
receiving the load factor value in an information element from a serving cell with cell redirection information.

6. The method of claim 5, wherein the reception of the cell redirection information is included as part of a circuit switch fall back (CSFB) procedure.

7. The method of claim 6, wherein the CSFB procedure comprises redirecting communication from a LTE network to a time division synchronous code division multiple access (TD-SCDMA) network.

8. The method of claim 1 wherein the obtaining further comprises:
receiving the load factor value in an information element from the one or more cells as part of a cell selection or cell reselection procedure.

9. The method of claim 1, wherein the obtaining further comprises:
receiving a neighbor list identifying the one or more cells; and
receiving the load factor value for each cell in the neighbor list from each of the cells in the neighbor list.

10. The method of claim 1, wherein the obtaining further comprises:
receiving the load factor value in an information element, wherein the information element is communicated through at least one of:
an information element in a system information block (SIB) 7;
an information element in a cell parameter identifier; or
information elements associated with each cell in a neighbor list.

11. The method of claim 1, wherein the load factor value indicates a percentage value of loading in a cell.

12. An apparatus for wireless communication, comprising:
means for obtaining a RSCP value and a load factor value for each of one or more cells;
means for ranking the one or more cells based on a cell selection value derived from both the RSCP value and the load factor value; and
means for selecting a serving cell from the ranked one or more cells.

13. The apparatus of claim 12, wherein the means for selecting further comprises means for selecting a highest ranked cell of the one or more cells.

14. The apparatus of claim 12, wherein the means for selecting further comprises means for selecting a cell of the one or more cell that has a cell selection value above a threshold value.

15. The apparatus of claim 12, wherein RSCP value indicates a distance between a UE and a node-B from which the RSCP transmission is received.

16. The apparatus of claim 12, wherein the means for obtaining further comprises means for receiving the load factor value in an information element from a serving cell with cell redirection information.

17. The apparatus of claim 16, wherein the reception of the cell redirection information is included as part of a CSFB procedure.

18. The apparatus of claim 17, wherein the CSFB procedure comprises redirecting communication from a LTE network to a TD-SCDMA network.

19. The apparatus of claim 12, wherein the means for obtaining further comprises means for receiving the load factor value in an information element from the one or more cells as part of a cell selection or cell reselection procedure.

20. The apparatus of claim 12, wherein the means for obtaining further comprises:
means for receiving a neighbor list identifying the one or more cells; and
means for receiving the load factor value for each cell in the neighbor list from each of the cells in the neighbor list.

21. The apparatus of claim 12, wherein the means for obtaining further comprises means for receiving the load factor value in an information element, wherein the information element is communicated through at least one of:
an information element in a SIB 7;
an information element in a cell parameter identifier; or
information elements associated with each cell in a neighbor list.

22. The apparatus of claim 12, wherein the load factor value indicates a percentage value of loading in a cell.

23. A computer program product, comprising:
a computer-readable medium comprising code for:
obtaining a RSCP value and a load factor value for each of one or more cells;
ranking the one or more cells based on a cell selection value derived from both the RSCP value and the load factor value; and
selecting a serving cell from the ranked one or more cells.

24. The computer program product of claim 23, wherein the computer-readable medium further comprising code for selecting a highest ranked cell of the one or more cells.

25. The computer program product of claim 23, wherein the computer-readable medium further comprising code for selecting a cell of the one or more cell that has a cell selection value above a threshold value.

26. The computer program product of claim 23, wherein RSCP value indicates a distance between a UE and a node-B from which the RSCP transmission is received.

27. The computer program product of claim 23, wherein the computer-readable medium further comprising code for:
receiving the load factor value in an information element from a serving cell with cell redirection information.

28. The computer program product of claim 27, wherein the reception of the cell redirection information is included as part of a circuit switch fall back (CSFB) procedure.

29. The computer program product of claim 28, wherein the CSFB procedure comprises redirecting communication from a LTE network to a TD-SCDMA network.

30. The computer program product of claim 23, wherein the computer-readable medium further comprising code for:
receiving the load factor value in an information element from the one or more cells as part of a cell selection or cell reselection procedure.

31. The computer program product of claim 23, wherein the computer-readable medium further comprising code for:
receiving a neighbor list identifying the one or more cells; and
receiving the load factor value for each cell in the neighbor list from each of the cells in the neighbor list.

32. The computer program product of claim 23, wherein the computer-readable medium further comprising code for receiving the load factor value in an information element, wherein the information element is communicated through at least one of:
an information element in a SIB 7;
an information element in a cell parameter identifier; or
information elements associated with each cell in a neighbor list.

33. The computer program product of claim 23, wherein the load factor value indicates a percentage value of loading in a cell.

34. An apparatus for wireless communication, comprising:
at least one processor; and
a memory coupled to the at least one processor,
wherein the at least one processor is configured to:
obtain a RSCP value and a load factor value for each of one or more cells;
rank the one or more cells based on a cell selection value derived from both the RSCP value and the load factor value; and
select a serving cell from the ranked one or more cells.

35. The apparatus of claim 34, wherein the at least one processor is further configured to select a highest ranked cell of the one or more cells.

36. The apparatus of claim 34, wherein the at least one processor is further configured to select a cell of the one or more cell that has a cell selection value above a threshold value.

37. The apparatus of claim 34, wherein RSCP value indicates a distance between a UE and a node-B from which the RSCP transmission is received.

38. The apparatus of claim 34, wherein the at least one processor is further configured to:
receive the load factor value in an information element from a serving cell with cell redirection information.

39. The apparatus of claim 38, wherein the reception of the cell redirection information is included as part of a CSFB procedure.

40. The apparatus of claim 39, wherein the CSFB procedure comprises redirecting communication from a LTE network to a TD-SCDMA network.

41. The apparatus of claim 34, wherein the at least one processor is further configured to:
receive the load factor value in an information element from the one or more cells as part of a cell selection or cell reselection procedure.

42. The apparatus of claim 34, wherein the at least one processor is further configured to:
receive a neighbor list identifying the one or more cells; and
receive the load factor value for each cell in the neighbor list from each of the cells in the neighbor list.

43. The apparatus of claim 34, wherein the at least one processor is further configured to receive the load factor value in an information element, wherein the information element is communicated through at least one of:
an information element in a SIB 7;
an information element in a cell parameter identifier; or
information elements associated with each cell in a neighbor list.

44. The apparatus of claim 34, wherein the load factor value indicates a percentage value of loading in a cell.
